(19) United States
(12) Patent Application Publication
(10) Pub. No.: US 2019/0264038 A1
(43) Pub. Date: Aug. 29, 2019

(54) LIQUID BINDER FOR REFRACTORY COATINGS OF FERROUS METALS

(71) Applicant: ZYP Coatings, Inc., Oak Ridge, TN (US)

(72) Inventors: Cressie E. Holcombe, JR., Knoxville, TN (US); William Brent Webb, Oak Ridge, TN (US)

(73) Assignee: ZYP Coatings, Inc., Oak Ridge, TN (US)

(21) Appl. No.: 15/960,779

(22) Filed: Apr. 24, 2018

Related U.S. Application Data
(63) Continuation-in-part of application No. 15/906,361, filed on Feb. 27, 2018.

(51) Int. Cl. C09D 5/08; C09D 1/00; B05D 1/28; B05D 3/02; B05D 7/14

(52) U.S. Cl. CPC C09D 5/08; C09D 1/00; B05D 7/14; B05D 3/0254; B05D 1/28

(57) ABSTRACT

A dry composition comprising 2 to 30 weight percent R₂O (wherein R₂O is an alkali metal oxide, K₂O, Na₂O, Li₂O or mixtures thereof); 10 to 74 weight percent SiO₂; and 23 to 79 weight percent B₂O₃. Aqueous solutions and/or colloidal suspensions (thus referred to as solution-suspensions) are used to blend to give a liquid-binder which, on drying, contains the composition within the range given above in the R₂O—SiO₂—B₂O₃ system. The dry composition is mixed with sufficient H₂O to form the solution-suspensions. As described herein H₂O may also be present in some additional additive.

The current application is a continuation-in-part of U.S. application Ser. No. 15/906,361 filed Feb. 27, 2018.

### BACKGROUND OF THE INVENTION

The present invention relates generally to the field of ceramic coatings and methods of making ceramic coatings and to systems for binding coatings with ferrous metals.

The present invention also relates to methods of forming ceramic aqueous suspensions to form binders and ceramic composition based coatings on metal substrates. The coatings of the present invention have various uses and are preferably flexible, durable, hard, and dense.

### SUMMARY

The parent application of which this application is a continuation-in-part defines a tough, dense, hard, corrosion resistant, very flexible coating for ferrous metals found in the system K₂O—SiO₂—B₂O₃ or using Na₂O or Li₂O whereby the coating is made very corrosion resistant to molten aluminum by adding boron nitride (h-BN, hexagonal-Boron Nitride) into the composition. All of the characteristics of these coatings as described therein are incorporated herein by reference as is the entire disclosure of the parent application.

It is currently an object of this invention to provide a binder composition for ferrous metals which can be provided as an aqueous solution-suspension for application to ferrous metals.

It is an additional object of this invention to provide such an aqueous solution-suspension that the addition of boron nitride forms a coating which is resistant to molten aluminum.

### DETAILED DESCRIPTION

The objects of this invention are achieved with a dry composition comprising 2 to 30 weight percent R₂O (wherein R₂O is an alkali metal oxide, K₂O, Na₂O, Li₂O or mixtures thereof); 10 to 74 weight percent SiO₂; and 23 to 79 weight percent B₂O₃. Aqueous solutions and/or colloidal suspensions (thus referred to as solution-suspensions) are used to blend to give a liquid-binder which, on drying, contains the composition within the range given above in the R₂O—SiO₂—B₂O₃ system. The dry composition is mixed with sufficient H₂O to form the solution-suspensions. As described herein, required H₂O may also be present in the additional raw material additives.

Aqueous binders made with low solids percentage have an appearance of clear liquid to milky liquid with some resembling egg-white consistency, depending on the alkali used, order of addition, and overall solids content of the binder. Keeping the solids level as low as possible allows adding refractory ceramic powder to create a paintable coating such that this coating can be applied to metal surfaces and then heated up to a bake-on temperature. The first time heat-up allows the ingredients of the aqueous binder to coalesce into a strong bond both to the metal substrate and to the refractory ceramic powder additive. The resulting coating has many of the properties of the refractory ceramic additive. Thus, boron nitride addition leads to a BN coating that is strongly bonded to the metal and to itself, giving a tough, flexible coating of BN that exhibits the highly useful properties of BN.

The thickness of the coating and its properties depend on the initial applied coating, after drying, thickness as well as the composition of the coating. The coating can vary from 0.0002 inch (0.2 mil) as a very thin coating up to 0.008 inch (8 mils) if multiple applications by brushing, dipping, or air spraying are done. Generally, thinner coatings are much better for thermal cycling applications.

Examples of raw materials that may be used to form the R₂O—SiO₂—B₂O₃ system comprise:
Potassium Tetraborate powder (“KBO”, K2B4O7*4H2O)
Ammonium Pentaborate powder (“APB”, NH4B5O8*4H2O)
Potassium Hydroxide solution (45 wt. %)
Colloidal Silica, SiO2 Bindzil 830 with 30 wt. % SiO2
Colloidal Silica, SiO2 Bindzil 9950 with 50 wt. % SiO2
Potassium Silicate powder, Kasolv 16
Potassium Silicate solution, Kasil 6
Polybor (Disodium Octaborate Tetrahydrate, Na2B8O13*4H₂O)
“N” Type Sodium Silicate
Lithium Polysilicate (LithPoly) with 22 wt. % solids of composition
Li2O*4.8SiO2
Lithium Hydroxide Monohydrate (LiOH*H2O) and mixtures thereof

This may be further modified with the addition of Al2TiO5, BaSO4, CeO2, Y2O3, MgAl2O4, Al2O3, Si—Al—On, SiC, and mixtures thereof.

### SPECIFIC EXAMPLES

### Example 1

I. Two liquid suspensions were separately prepared.

Liquid A was prepared using a magnetic stirrer with 3.8 grams of ammonium pentaborate to 40 grams of water. The mixture was very clear, dissolved easily and had a pH of 7.8.

Liquid suspension B was prepared also using a magnetic stirrer with 2.71 grams of Kasolv-16 to 40 grams of water. This liquid was slightly cloudy with a pH of approximately 10. Kasolv-16 comprises 32.4% K2O, 52.8% SiO2, 14.5% H₂O. Note that Kasolv 16 provides a portion of the required H₂O.

Composition A was added to composition B within a magnetic stirrer. This composition looked uniform with a pH of about 8.5.

After one day there was some separation but was easily recombined with shaking.

II. Liquid A was prepared by combining 2.94 grams ammonium pentaborate to 40 grams of water. This composition was very clear and dissolved very easily. The pH was approximately 7.

Liquid B was prepared using 5.36 grams of Kasil 6 to 40 grams of water. This was a clear liquid with a pH of approximately 10.

Kasil 6 comprises 12.7% K2O, 26.5% SiO2, and 60.8% H₂O.

Composition B was added to composition A within a magnetic stirrer. The suspension had a uniform appearance with a pH of about 8.5. After one day there was no visible separation.

Both of the compositions, I and II, were painted onto a 304 stainless steel coupon which required brushing with a foam rubber brush harshly for about a minute to get the liquids to “wet” and coat the coupon uniformly. This was heated to 930° C. for 30 minutes and led to a thin coating (about 0.2 mil or about 5 microns thick). This demonstrates that these binder compositions are similar to those described in the parent application, with “I’ being composition G and “II” being composition J.

### Example 2

III. A suspension A was prepared by a magnetic stirring with 2.76 grams of ammonium pentaborate to 30 grams of water. After stirring, the composition appeared to be very clear and dissolved easily. The pH was approximately 7.8.

A solution B was formed with 4.4 grams of potassium tetraborate (K2B407*4H20) to 30 grams of water. After stirring a clear liquid was formed with a pH of approximately 9.5.

Solutions A and B were combined with magnetic stirring to form a clear liquid.

A suspension C was formed with 5.68 grams of “9950” colloidal silica to 30 grams of water with magnetic stirring. A hazy liquid with a pH of approximately 9 was formed.

Suspensions A, B and C were mixed with a magnetic stirrer which formed a uniform hazy liquid with a pH of about 8. This composition after firing corresponds to composition number J of the parent application.

IV. A suspension was formed with 2.76 grams of ammonium pentaborate to 30 grams of water. A clear suspension was formed with a pH in the range of 7-8.

A suspension B was formed with magnetic stirring of 4.4 grams of potassium tetraborate to 30 grams of water forming a clear liquid with a pH of approximately 9.5.

Suspensions A and B were mixed with magnetic stirring to form a uniform clear liquid.

A suspension C was formed with 9.47 grams of “830” colloidal silica to 30 grams of water. A clear liquid with a pH of about 10 resulted.

Suspension C was added to the B-A suspension forming a uniform hazy liquid with a pH of about 8.5. This composition after firing corresponds to composition number J of the parent application.

Both of the above suspensions III and IV were painted onto a 304 stainless steel coupon that required brushing with a foam rubber brush harshly for about a minute to get the liquids to wet and coat the coupon uniformly. The above coupons were heated to 930° C. for 30 minutes in air which led to a very thin coating (about 0.2 mil or only 5 microns). This was similar to the results achieved in the parent application where there was no the use of an aqueous solution suspension.

### Example 3

1. 5.5 grams of Kasolv-16 was mixed with 7.72 grams of ammonium pentaborate, 1.67 grams “9950” colloidal silica and 85.11 grams of water were mixed. This was shown to be an effective binder.

2. 4.26 grams of Kasolv-16 was mixed with 5.98 grams of ammonium pentaborate and 89.76 grams of water. This had a pH of 8.85 and was also an effective binder.

The composition 2 was painted onto a 304 stainless steel coupon that still required brushing with a foam rubber brush harshly to achieve wetting and coat the coupon uniformly. After drying, this was heated to 930° C. for 30 minutes which led to a very thin and somewhat splotchy coating but did show this to be a feasible way to utilize the composition alone as a binder phase.

Further testing with these binder composition systems showed that they can be used with added boron nitride, cerium oxide (in powder or as a pH basic solution that is commercially available), as well as other refractories in a suspension system to bind the refractory materials to a ferrous state materials.

This compares with the compositions described in the parent application hereof wherein it was often necessary to form a frit or calcine the ingredients in order to get a uniform binder phase.

The above examples utilizing aqueous binder liquids do not require any calcination or fritting to yield tough, hard, flexible coatings described in the parent application hereto. When boron nitride is desired in the paint formulation, it is preferred that the content of the boron nitride be 5% or more based on the solids content, i.e. after heating to the bake-on temperature. Boron nitride additions allow non-wetting but molten aluminum as do some other additives. Additional additives comprise, but are not limited to, ceria, yttria, NiAl, TiAl, MgAl204, Al203, Si—Al—ON, SiC. The addition of 1 to 2% Al2O3 has found to increase the useful temperature to over 100° C. The only limitation is that the additive be stable within an aqueous suspension that is somewhat alkaline, generally pH 8-9.

Potassium oxide, sodium oxide, lithium oxide or mixtures thereof represent the “R” in the ternary composition R2O—SiO2—B203 system, which can be achieved by ingredients that are either soluble completely in water or as dry ingredients. Some are commercially available as aqueous liquids or colloidal liquids.

Organic or inorganic binder/suspenders in low levels can be added if desired for paintability or suspendability. Preferably, the organic binders/polymers would completely oxidize away on first heat-up/bake-on or they would contain small amounts of R2O after heat-up/bake-on. Inorganic binders would preferably contain ingredients that would not impair the properties of the resultant glass-ceramic bond-coat from the R2O—SiO2—B203 system.

Example of ferrous metal useful in forming the coatings of this invention include:
Stainless 304
Stainless 316
Stainless 430
Haynes alloy 214
Inconel 718
H13

Having generally described the invention in exemplary terms, such terms are not deemed to be binding but limited only by the following appended claims.

What is claimed:

1. A liquid binder system for binding ceramic and metal systems, comprising:
an aqueous solution-suspension of R₂O—SiO₂—B2O3 comprising in the dry state a composition of 2 to 30 weight percent R₂O, wherein R₂O is an alkali metal oxide; between 10 to 74 weight percent SiO₂; and between 23 to 79 weight percent B₂O₃.

2. The liquid binder system of claim 1 where the aqueous solution-suspension is formed from materials selected from the group comprising:
Potassium Tetraborate powder (“KBO”, K2B4O7*4H2O)
Ammonium Pentaborate powder (“APB”, NH4B5O8*4H2O)
Potassium Hydroxide solution (45 wt. %)
Colloidal Silica, SiO2 Bindzil 830 with 30 wt. % SiO2
Colloidal Silica, SiO2 Bindzil 9950 with 50 wt. % SiO2
Potassium Silicate powder, Kasolv 16
Potassium Silicate solution, Kasil 6
Polybor (Disodium Octaborate Tetrahydrate, Na2B8O13*4H2O)
“N” Type Sodium Silicate
Lithium Polysilicate (LithPoly) with 22 wt. % solids of composition Li2O*4.8SiO2
Lithium Hydroxide Monohydrate (LiOH*H2O) and mixtures thereof.

3. The liquid binder system of claim 2 further comprising boron nitride (h-BN) content which is >/=5% of the total solids content after heating to 800 C in an air atmosphere.

4. The liquid binder system of claim 1 further comprising a material selected from the group of Al2TiO5, BaSO4, CeO2, Y2O3, MgAl2O4, Al2O3, Si—Al—ON, SiC, and mixtures thereof.

5. A ferrous metal having a coating thereon formed from the liquid binder system of claim 1 wherein the ferrous metal is selected from the group comprised of:
Stainless 304
Stainless 316
Stainless 430
Haynes alloy 214
Inconel 718
H13

7. The liquid binder system of claim 4 further comprising 1-2% Al2O3 to extend its use temperature in air atmospheres to over 1000 C.
